(19) United States
(12) Patent Application Publication
(10) Pub. No.: US 2023/0298234 A1
(43) Pub. Date: Sep. 21, 2023

(54) DIGITAL IMAGE SURFACE EDITING WITH USER-SELECTED COLOR

(71) Applicant: Home Depot Product Authority, LLC, Atlanta, GA (US)

(72) Inventors: Muhammad Osama Sakhi, Lilburn, GA (US); Estelle Afshar, Atlanta, GA (US); Yuanbo Wang, Round Rock, TX (US)

(21) Appl. No.: 17/592,480

(22) Filed: Feb. 3, 2022

(51) Int. Cl. G06T 11/60; G06T 11/00

(52) U.S. Cl. CPC G06T 11/60; G06T 11/001

(57) ABSTRACT

A method for editing a digital image includes receiving a user input indicative of a portion of an original digital image, determining an area of a surface comprising the portion by applying a plurality of different masks to the original image, receiving a user selection of a color to be applied to the original image to create a modified image, determining a modified brightness value for each pixel of the surface in the modified image according to original brightness values of corresponding pixels in the original image, and creating the modified image by applying the selected color to the surface according to the modified brightness values.

### TECHNICAL FIELD

This disclosure generally relates to revision of digital images, including to include user-selected colors on surfaces in the images.

### BACKGROUND

Digital images may be altered or revised by changing a color, hue, tone, or lighting condition of one or more portions of the image, such as a surface in the image.

### SUMMARY

In a first aspect of the present disclosure, a method for editing a digital image is provided. The method includes receiving a user input indicative of a portion of an original digital image, determining an area of a surface comprising the portion by applying a plurality of different masks to the original image, receiving a user selection of a color to be applied to the original image to create a modified image, determining a modified brightness value for each pixel of the surface in the modified image according to original brightness values of corresponding pixels in the original image, and creating the modified image by applying the selected color to the surface according to the modified brightness values.

In an embodiment of the first aspect, the plurality of different masks includes one or more of a segmentation mask, a color mask, or an edge mask.

In an embodiment of the first aspect, determining the area of the surface comprising the portion by applying the plurality of different masks to the image includes defining the surface where at least two of the masks agree. In a further embodiment of the first aspect, determining the area of the surface comprising the portion by applying the plurality of different masks to the image includes defining the surface where all of the masks agree.

In an embodiment of the first aspect, the method further includes applying a morphological smoothing to boundaries of the area.

In an embodiment of the first aspect, the method further includes displaying the modified image to the user in response to one or more of the user input indicative of the portion of the original image or the user selection of the color.

In an embodiment of the first aspect, the method further includes receiving the original image from the user.

In a second aspect of the present disclosure, a non-transitory, computer readable medium storing instructions is provided. When the instructions are executed by a processor, the instructions cause the processor to receive a user input indicative of a portion of an original digital image, determine an area of a surface comprising the portion by applying a plurality of different masks to the original image, receive a user selection of a color to be applied to the original image to create a modified image, determine a modified brightness value for each pixel of the surface in the modified image according to original brightness values of corresponding pixels in the original image, and create the modified image by applying the selected color to the surface according to the modified brightness values.

In an embodiment of the second aspect, the plurality of different masks includes one or more of a segmentation mask, a color mask, or an edge mask.

In an embodiment of the second aspect, determining the area of the surface comprising the portion by applying the plurality of different masks to the image includes defining the surface where at least two of the masks agree. In a further embodiment of the second aspect, determining the area of the surface comprising the portion by applying the plurality of different masks to the image includes defining the surface where all of the masks agree.

In an embodiment of the second aspect, the computer readable medium stores further instructions that, when executed by the processor, cause the processor to apply a morphological smoothing to boundaries of the area.

In an embodiment of the second aspect, the computer readable medium stores further instructions that, when executed by the processor, cause the processor to display the modified image to the user in response to one or more of the user input indicative of the portion of the original image or the user selection of the color.

In an embodiment of the second aspect, the computer readable medium stores further instructions that, when executed by the processor, cause the processor to receive the original image from the user.

In a third aspect of the present disclosure, a system is provided that includes a processor and a non-transitory computer-readable medium storing instructions. When executed by the processor, the instructions cause the processor to receive a user input indicative of a portion of an original digital image, determine an area of a surface comprising the portion by applying a plurality of different masks to the original image, receive a user selection of a color to be applied to the original image to create a modified image, determine a modified brightness value for each pixel of the surface in the modified image according to original brightness values of corresponding pixels in the original image, and create the modified image by applying the selected color to the surface according to the modified brightness values.

In an embodiment of the third aspect, the plurality of different masks includes one or more of a segmentation mask, a color mask, or an edge mask.

In an embodiment of the third aspect, determining the area of the surface including the portion by applying the plurality of different masks to the image includes defining the surface where at least two of the masks agree.

In an embodiment of the third aspect, determining the area of the surface comprising the portion by applying the plurality of different masks to the image includes defining the surface where all of the masks agree.

In an embodiment of the third aspect, the computer-readable medium stores further instructions that, when executed by the processor, cause the processor to apply a morphological smoothing to boundaries of the area.

In an embodiment of the third aspect, the computer-readable medium stores further instructions that, when executed by the processor, cause the processor to display the modified image to the user in response to one or more of the user input indicative of the portion of the original image or the user selection of the color.

### BRIEF DESCRIPTION OF THE DRAWINGS

This patent or application file contains at least one drawing executed in color. Copies of this patent or patent application publication with color drawing(s) will be provided by the Office upon request and payment of the necessary fee.

FIG. 1 is a diagrammatic view of an example system for revising digital images.

FIG. 2 is a flow chart illustrating an example method of revising a digital image.

FIG. 3 is a flow chart illustrating an example method of determining an area and boundaries of a region of a digital image to be revised.

FIGS. 4A-4E are various views of an original image and different masks on that original image for determining an area and boundaries of a region of the original image to be revised.

FIG. 5A is an example original image.

FIG. 5B illustrates an example color to be applied to a region of the original image of FIG. 5A to create a modified image.

FIGS. 5C-5E are various revised versions of the image of FIG. 5A revised with the paint color of FIG. 5B according to different brightness settings.

FIG. 6 is a diagrammatic view of an example embodiment of a user computing environment.

### DETAILED DESCRIPTION

Known digital image editing systems and methods do not adequately identify a surface to be revised in response to a user’s selection of a portion of that surface, and do not adequately account for variable lighting conditions throughout the image when applying a color revision. For example, a user may wish to review the appearance of a new paint color on a wall based only on a digital image of the wall and its surroundings. The instant disclosure includes several techniques for providing improved image editing for paint color simulation and other applications of single colors to single surfaces under variable lighting conditions. Such techniques may include, for example, applying multiple masks to the original image to identify the area and boundaries of a user-selected surface, adjusting the brightness of the revised surface in the revised image on a pixel-by-pixel basis according to the brightness of the pixels in the original image, and/or other techniques.

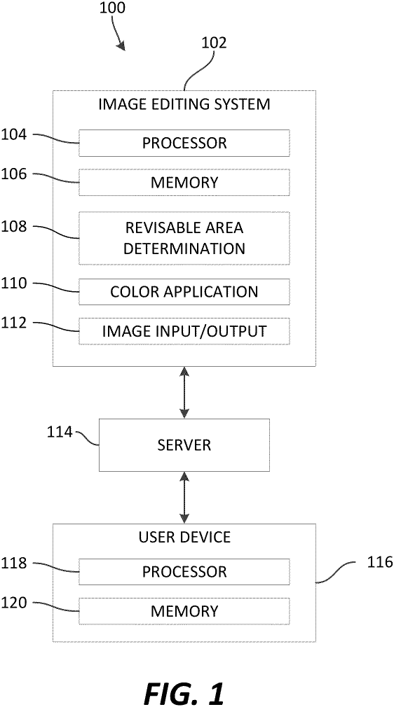

Referring now to the drawings, wherein like numerals refer to the same or similar features in the various views, FIG. 1 is a diagrammatic view of an example digital image editing system 100. The system 100 may be used to simulate the appearance of one or more paint colors on an image of a structure, for example. The approach of the system 100, however, is applicable to digital image editing of any kind that includes revising an identifiable surface.

The system 100 may include an image editing system 102 that may include a processor 104 and a non-transitory, computer-readable medium (e.g., memory) 106 that stores instructions that, when executed by the processor 104, cause the processor 104 to perform one or more steps, methods, processes, etc. of this disclosure. For example, the image editing system 102 may include one or more functional modules 108, 110, 112 embodied in hardware and/or software. In some embodiments, one or more of the functional modules 108, 110, 112 may be embodied as instructions in the memory 106.

The functional modules 108, 110, 112, of the image editing system may include a revisable area determination module 108 that may determine the boundaries, and area within the boundaries, of a region to be revised within an original image. In general, the revisable area determination module 108 may identify one or more continuous surfaces and objects within the image and may delineate such surfaces and objects from each other. For example, in embodiments in which the system 100 is used to simulate application of paint to one or more surfaces in an image, such as a painted wall, a backsplash, a tile wall, etc., the revisable area determination module 108 may identify that surface and delineate it from other surfaces and objects in the image. In some embodiments, the revisable area determination module 108 may identify the revisable area responsive to a user input. For example, the revisable area determination module 108 may receive a user input that identifies a particular portion of the image and may identify the boundaries and area of the surface that includes the user-identified portion. As a result, the user may indicate a single portion of a surface to be revised, and the revisable area determination module 108 may determine the full area and boundaries of that surface in response to the user input.

The image editing system 102 may further include a color application module 110 that may revise the original image by applying a color, such as a user-selected color, to the revisable area identified by the revisable area determination module 108. The color application module 110 may utilize one or more color blending techniques to present the applied color in similar lighting conditions as the original color, in some embodiments.

The image editing system 102 may further include an image input/output module 112 that may receive the original image from the user and may output the revised image to the user. The output may be in the form of a display of the revised image, and/or transmission of the revised image to the user for storage on the user computing device 116. Through the input/output module 112, the image editing system 102 may additionally receive user input regarding one or more thresholds and/or masks applied by the revisable area determination module 108 or the color application module 110, as discussed herein.

The system 100 may further include a server 114 in electronic communication with the image editing system 102 and with a user computing device 116. The server 114 may provide a website, data for a mobile application, or other interface through which the user of the user computing device 116 may upload original images, receive revised images, and/or download one or more of the modules 108, 110, 112 for storage in non-transitory memory 120 for local execution by processor 122 on the user computing device 116. Accordingly, some or all of the functionality of the image editing system 102 described herein may be performed locally on the user computing device 116, in embodiments.

In operation, a user of a device 120 may upload an original image to the image editing system 102 via the server 114, or may load the original image for use by a local copy (e.g., application) of the modules 108, 110, 112 on user computing device 116. The loaded image may be displayed to the user, and the user may select a portion of the image (e.g., by clicking or tapping on the image portion) and may select a color to be applied to that portion. In response, the revisable area determination module 108 may identify a revisable surface that includes the user-selected portion, the color application module may apply the user-selected color to the surface to create a revised image, and the image input/output module 112 may output the revised image to the user, such as by displaying the revised image on a display of the user computing device 116 and/or making the revised image available for storage on the user computing device 116 or other storage. The determination of the revisable area, application of color, and output of the image may be performed by the image editing system 102 automatically in response to the user’s image portion selection and/or color selection. In addition, the user may select multiple image portion and color pairs, and the image editing system 102 may identify the revisable area, apply the user-selected color, and output the revised image to the user automatically in response to each input pair. For example, the user may select a new color with respect to an already-selected image portion, and the image editing system 102 may apply the new user-selected color in place of the previous user-selected color, and output the revised image to the user. In another example, the user may select a second portion of the same image, and the image editing system 102 may identify the revisable area of the second image portion, apply the user-selected color to the second revisable area, and output the revised image to the user that includes user-selected color applied to the first and second revisable areas.

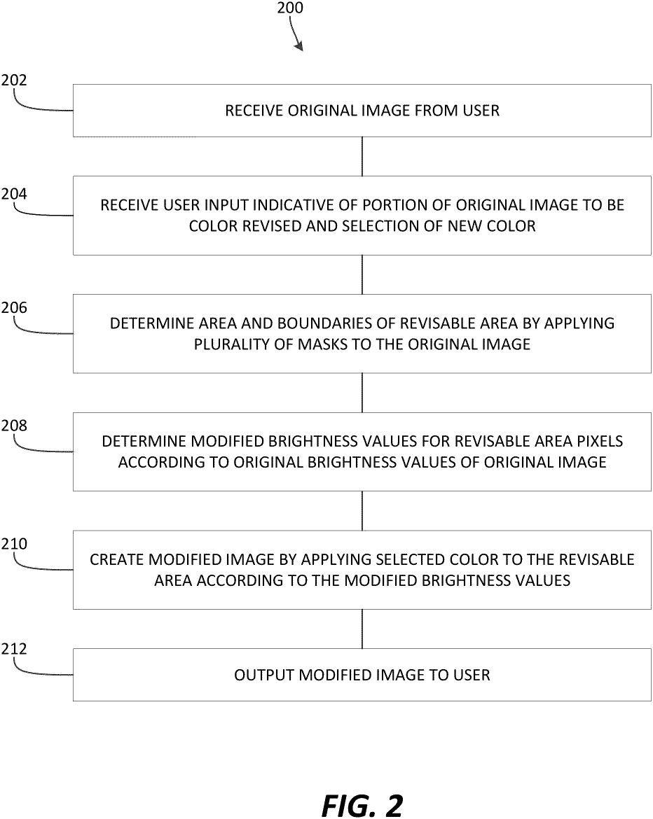

FIG. 2 is a flow chart illustrating an example method 200 of revising a digital image. One or more portions of the method 200 may be performed by the image editing system 102 and/or the user computing device 116, in embodiments.

The method 200 may include, at block 202, receiving an original image from a user. The image may be received via upload, or for loading into an application for local execution, or by retrieval from cloud or other network storage. The image may be original relative to a later, revised image, and may or may not have been captured by the user from which the image is received.

The method 200 may further include, at block 204, receiving user input indicative of a portion of the original image to be color revised and a user selection of a new color to be applied to the original image portion. The user may provide their input indicative of the original image portion by clicking or tapping on a surface in the image to be painted, in embodiments in which the method 200 is applied to simulate a new paint color in an image. Additionally or alternatively, the user may select tap multiple points on the surface and/or trace what the user believes to be the outline of the surface. In other embodiments, the user may provide similar input with respect to an object the color of which is to be changed in the image.

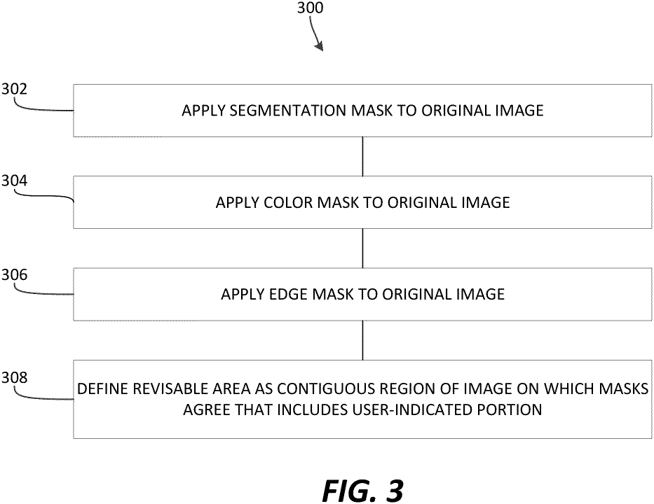

The method 200 may further include, at block 206, determining the area and boundaries of the color revisable area indicated by the user. Details of an example implementation of block 206 are discussed below with respect to the method 300 of FIG. 3.

Turning to FIG. 3, which is a flow chart illustrating an example method 300 of determining an area and boundaries of a region of a digital image to be revised, one or more masks may be applied to the original image to find the revisable area. One or more portions of the method 200 may be performed by the image editing system 102 and/or the user computing device 116, in embodiments.

The method 300 may include, at block 302, applying a segmentation mask to the original image. The segmentation mask may be or may include a machine learning model trained to identify objects and boundaries within the image. Such a machine learning model may include a convolutional encoder-decoder structure. The encoder portion of the model may extract features from the image through a sequence of progressively narrower and deeper layers, in some embodiments. The decoder portion of the model may progressively grow the output of the encoder into a pixel-by-pixel segmentation mask that resembles the resolution of the input image. The model may include one or more skip connections to draw on features at various spatial scales to improve the accuracy of the model (relative to a similar model without such skip connections).

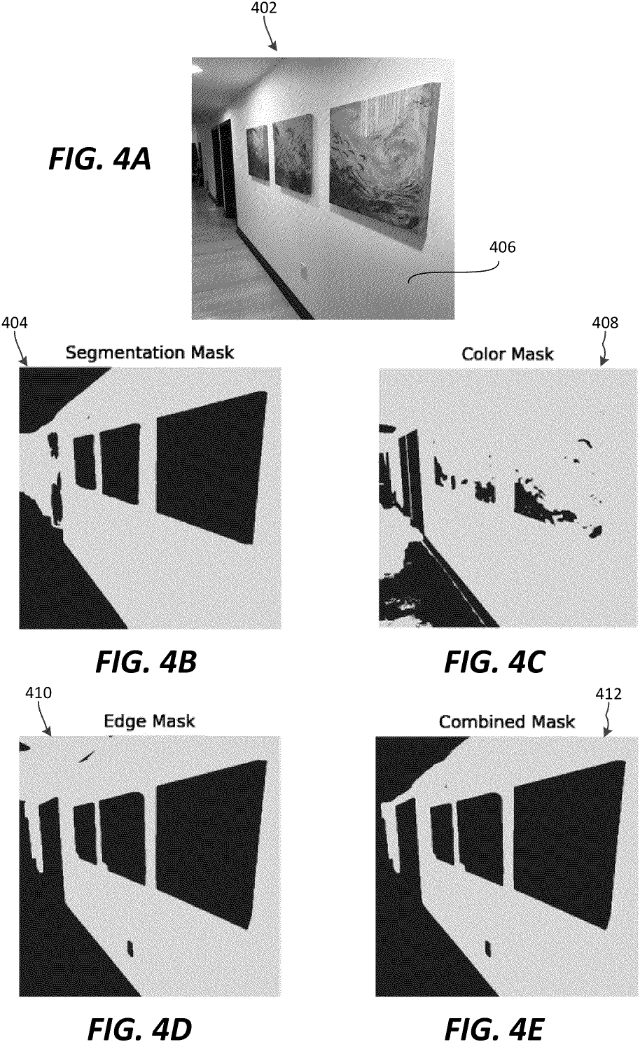

FIGS. 4A-4E illustrate an original image 402 and the result of various masks applied to that image. FIG. 4B illustrates the result 404 of a segmentation mask according to block 302. As can be seen in FIG. 4B, the segmentation mask identifies the boundaries of surfaces and objects within the original image. In the example of FIGS. 4A-4E, the user may have selected portion 406 of the original image 402 by tapping, clicking, or otherwise making an input on or at portion 406.

Referring again to FIG. 3, the method 300 may further include, at block 304, applying a color mask to the original image. The color mask may be based on the color of one or more portions (e.g., pixels or groups of pixels) selected by the user, and may generally determine which portions (e.g., pixels or groups of pixels) in the original image are the same (or substantially the same) color as the image portion(s) selected by the user. In some embodiments, block 304 may include converting the original image to the LAB color space, determining the L, A, and B parameter values of the user-selected portion of the original image, and comparing the L, A, and B values of each other portion of the image to the L, A, and B parameter values of the user-selected portion. Original image portions that are within a threshold difference of one or more of the parameters (e.g., all three parameters) may be considered the same color by the color mask. Accordingly, block 304 may include, for one or more portions of the original image (e.g., all portions of the original image), the color space parameter values of the image portion may be compared to the color space parameter values of the user-selected portion of the image, a respective difference for each parameter may be computed, and those differences may be individually and/or collectively compared to one or more thresholds to determine if the portion is sufficiently similar to the user-selected portion to be considered the same color as the user-selected portion.

FIG. 4C is an example output 408 of a color mask according to block 304 applied to the image of FIG. 4A. In the example of FIG. 4C, the user has selected the wall coincident with portion 406, and thus the color mask has determined which portions of the image of FIG. 4A are the same or substantially the same color as the wall.

Referring again to FIG. 3, the method 300 may further include, at block 306, applying an edge mask to the original image. The edge mask may include, for example, a Canny edge detector, an HED edge detector, and/or a Dexined edge detector. The edge detector may identify edges of surfaces and objects within the image, including edges at the boundary of the user-selected portion. The edge mask may further include applying a flood fill to the area bounded by edges detected by the edge detector and which area includes the user-selected portion of the original image. The flooded area may be defined as the “masked” region of the original image by the edge mask.

FIG. 4D is an example output 410 of an edge mask according to block 306 applied to the image of FIG. 4A. As can be seen in FIG. 4D, the edge mask identifies the edges of objects within the original image with a higher degree of resolution than the segmentation mask.

In alternate embodiments, the method 300 may include applying a subset of the above-identified masks. For example, a segmentation mask and a color mask may be applied, without an edge mask. For example, an edge mask may be omitted when the surface to be revised includes a series of repeating shapes, such as tile. Still further, in some embodiments, a segmentation mask and an edge mask may be applied, without a color mask. For example, the color mask may be omitted when the surface to be revised is subject to extreme lighting conditions in the original image, or the user-selected surface includes multi-colored features, such as a marble countertop, multi-colored backsplashes, tile, or bricks, and/or the user-selected surface reflects colors from elsewhere in the space, such as a glass frame that scatters light or a glossy surface. In some embodiments, the method 300 may include receiving input from a user to disable one or more masks, and disabling the one or more masks in response to the user input. For example, the user may be provided with check boxes, radio buttons, or other input respective of the masks in the electronic interface in which the user selects the surface to be revised in the original image.

The method 300 may further include, at block 308, defining the revisable area as a contiguous region of the original image in which the masks agree and that includes the user-indicated portion. For example, referring to FIGS. 4A-4E, the revisable area is defined in FIG. 4E as the continuous region 412 (shown in yellow in the color images accompanying this application) in which masks 404, 408, 410 agree that a continuous surface exists that includes the user-selected portion 406.

Referring again to FIG. 2, the method 200 may further include, at block 208, determining modified brightness values for the pixels of the revisable area according to original brightness values of the original image. Such brightness values may be determined so that the revised image can appear to have the same lighting conditions as the revised portion of the original image.

In some embodiments, block 208 may include converting the color space of the image to the LAB parameter set, in which parameter L is the lightness (or brightness) of a pixel, and parameters A and B are color parameters (with A on the red-green colors and B on the blue-yellow colors).

Block 208 may further include determining brightness (e.g., parameter L in LAB space) values for each pixel in the revisable area using the individual brightness values of those corresponding pixels in the original image and according to an average brightness of some or all of the original image. For example, a revised brightness Lₒᵤₜₚᵤₜ of a pixel in the revised image may be calculated according to equations (1), (2), and (3) below:

$$\text{sL =} \left(1 - \text{s}\right) ⋅ \left({\text{L}}_{\text{src}} - {\text{L}}_{\text{target}}\right) \qquad \text{(Eq. 1)}$$

$$d L = \left(1 - d\right) ⋅ \left(\overline{{L}_{s r c}} - {L}_{t a r g e t}\right) \qquad \text{(Eq. 2)}$$

$${L}_{o u t p u t} = s L + d L + {L}_{t a r g e t} \qquad \text{(Eq. 3)}$$

where L_{src} is the brightness the pixel in the original image, L_{target} is the brightness of the user-selected color, L_{src} is the average brightness of the revisable area in the original image, in some embodiments, or of the entire original image, in other embodiments, and s and d are adjustable parameters. The value of s may be adjusted to adjust the variance of the revised image relative to the original image, where a larger value of s results in less variation. The value of d may be adjusted to alter the difference between the mean of the revised color relative to the mean of the original color, where a higher value of s results in more similar color means.

Returning to FIG. 2, the method 200 may further include, at block 210, creating a modified image by applying the user-selected color to the revisable area according to the brightness values determined at block 208. For example, in some embodiments, the image may be modified in the LAB color space, with the A and B parameter values of each pixel set according to the user-selected color, and the L parameter value of each pixel set according to the brightness values calculated at block 208.

In some embodiments, block 210 may further include applying an alpha blending function to the revisable area to combine the original color with the revised color. Alpha blending may result in a smoother transition between lightness variations in the modified image. In alpha blending, an alpha parameter may be set to determine the relative weights of the original and modified image pixel parameter values when calculating the final pixel parameter values for the revised image.

In some embodiments, alpha blending may be performed according to equations (4) and (5) below (e.g., in embodiments in which the image is revised in the LAB color space):

$${A}_{o u t p u t} = α ⋅ {A}_{t a r g e t} + \left(1 - α\right) ⋅ {A}_{s r c} \qquad \text{(Eq. 4)}$$

$${B}_{o u t p u t} = α ⋅ {B}_{t a r g e t} + \left(1 - α\right) ⋅ {B}_{s r c} \qquad \text{(Eq. 5)}$$

where Aₒᵤₜₚᵤₜ and Bₒᵤₜₚᵤₜ are the A and B parameter values, respectively, of a given pixel in the revised image, α is the alpha parameter, A_{target} and B_{target} are the A and B parameters, respectively, of the user-selected color, and A_{src} and B_{src} are the A and B parameter values, respectively, of the pixel in the original image.

Where alpha blending is applied, an interim set of pixel parameter values may be created based on the user-selected color and calculated brightness values, those interim values may be alpha blended with the pixel parameter values of the original image, and the resulting final pixel parameter values may be used for the revised image. In some embodiments, alpha blending may be omitted, and the “interim” values may be the final pixel parameter values used for the revised image.

In some embodiments, block 210 may further include applying a morphological smoothing operation to the boundary of the revisable area, or performing another smoothing or blurring operation. Such a smoothing or blurring operation may result in a more natural-looking boundary between the revised area and the surrounding unrevised portions of the original image. In some embodiments, the morphological smoothing operation may smooth pixels within the revisable area along the edge of the revisable area. In some embodiments, the morphological smoothing may be or may include a gaussian smoothing.

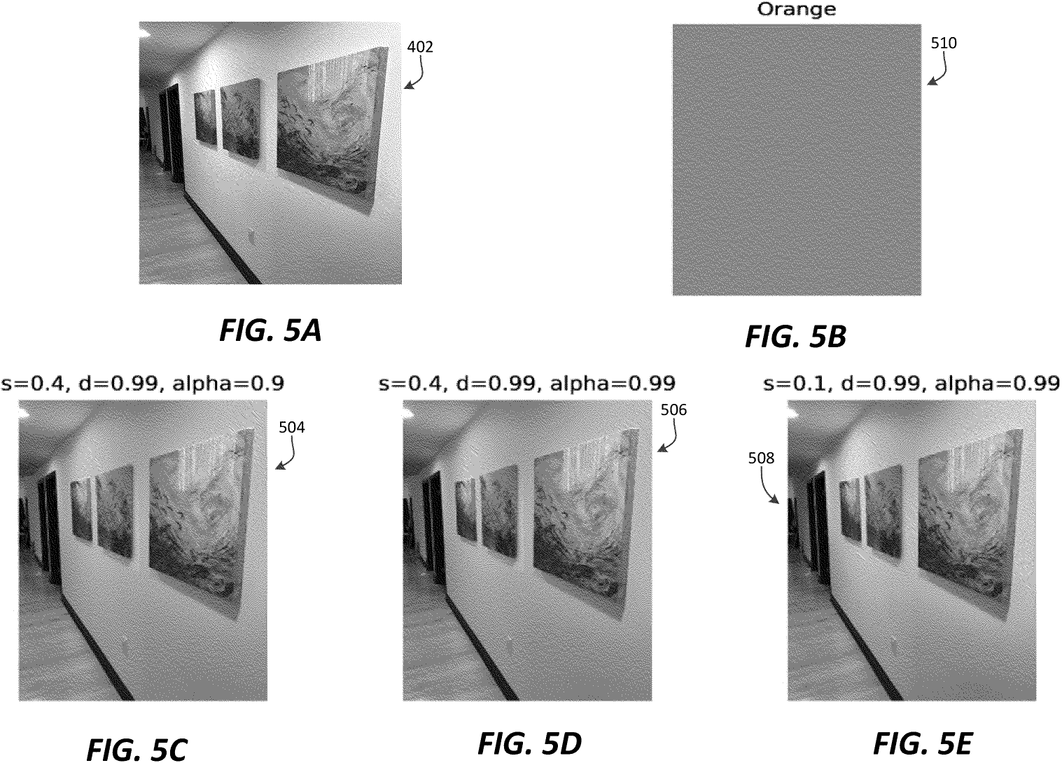

FIGS. 5A-5E illustrate the example original image 402 and various revised image versions 504, 506, 508, according to a user-selected color 510. The image versions apply different values of s, d, and alpha. In the embodiment of FIGS. 5A-5E, the alpha value is the weight of the modified image color in alpha blending (and, thus, one minus alpha is the weight of the original image color). Comparing FIGS. 5C and 5D to FIG. 5E, it can be seen that the lower s value of FIG. 5E results in higher brightness variance throughout the image relative to FIGS. 5C and 5D. Further, comparing FIG. 5C with FIG. 5D, it can be seen that the lower alpha value of FIG. 5C results in a greater weight of the white color of the original image, and thus an overall lighter shade of color relative to FIG. 5D.

Referring again to FIG. 2, the method 200 may further include, at block 212, outputting the modified image to the user. The modified image may be output by being automatically displayed to the user in response to the user’s selection of a color and/or original image portion, in some embodiments. Additionally or alternatively, the modified image may be provided to the user in file form for download to and/or storage on the user’s computing device or other storage of the user.

In some embodiments, the user may provide input regarding the sensitivity of one or more masks and/or one or more thresholds values or other values. For example, the user may provide input for the value of alpha (e.g., for use in equations (4) and (5) above) to set the relative weights of the original and modified image pixel parameter values when calculating the final pixel parameter values for the revised image. Additionally or alternatively, the user may provide input to set the sensitivity of the edge detector, one or more thresholds of the color mask, or the values of s and d for use in equations (1) and (2). Such user input may be received through the electronic interface in which the user provides the image and/or the user’s selection of a portion of the image, in some embodiments. For example, the interface may include one or more a text entry or slider interface elements for input. In some embodiments, the method 200 may include performing an initial revision according to blocks 202, 204, 206, 208, 210, and 212, then receiving user input regarding the sensitivity of one or more masks and/or one or more thresholds values or other values and dynamically further revising and outputting the image to the user in response to the user input.

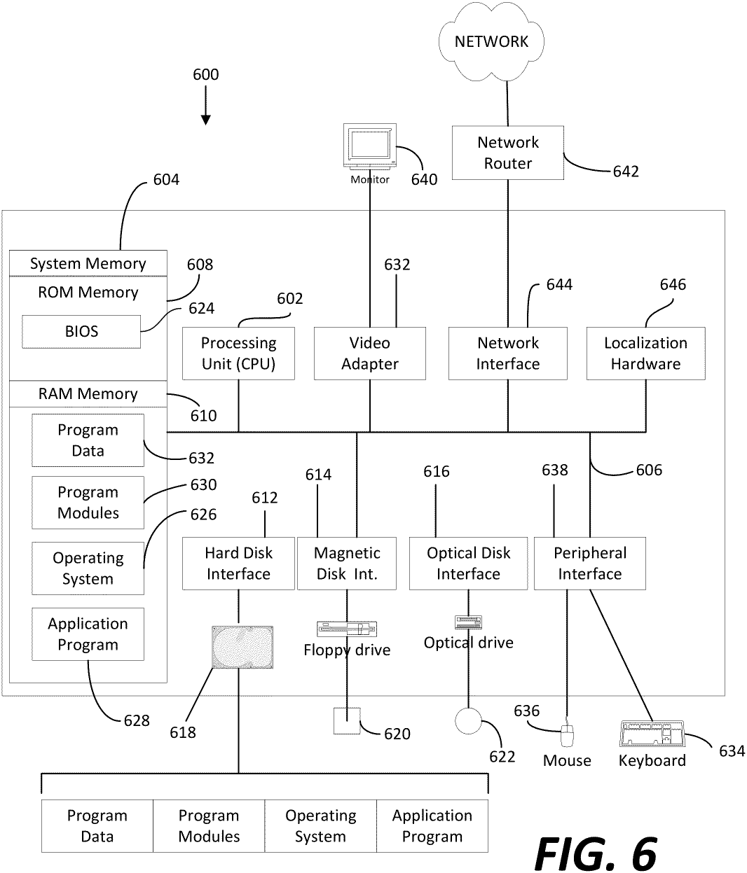

FIG. 6 is a diagrammatic view of an example embodiment of a user computing environment that includes a general purpose computing system environment 600, such as a desktop computer, laptop, smartphone, tablet, or any other such device having the ability to execute instructions, such as those stored within a non-transient, computer-readable medium. Furthermore, while described and illustrated in the context of a single computing system 600, those skilled in the art will also appreciate that the various tasks described hereinafter may be practiced in a distributed environment having multiple computing systems 600 linked via a local or wide-area network in which the executable instructions may be associated with and/or executed by one or more of multiple computing systems 600.

In its most basic configuration, computing system environment 600 typically includes at least one processing unit 602 and at least one memory 604, which may be linked via a bus 606. Depending on the exact configuration and type of computing system environment, memory 604 may be volatile (such as RAM 610), non-volatile (such as ROM 608, flash memory, etc.) or some combination of the two. Computing system environment 600 may have additional features and/or functionality. For example, computing system environment 600 may also include additional storage (removable and/or non-removable) including, but not limited to, magnetic or optical disks, tape drives and/or flash drives. Such additional memory devices may be made accessible to the computing system environment 600 by means of, for example, a hard disk drive interface 612, a magnetic disk drive interface 614, and/or an optical disk drive interface 616. As will be understood, these devices, which would be linked to the system bus 606, respectively, allow for reading from and writing to a hard disk 618, reading from or writing to a removable magnetic disk 620, and/or for reading from or writing to a removable optical disk 622, such as a CD/DVD ROM or other optical media. The drive interfaces and their associated computer-readable media allow for the nonvolatile storage of computer readable instructions, data structures, program modules and other data for the computing system environment 600. Those skilled in the art will further appreciate that other types of computer readable media that can store data may be used for this same purpose. Examples of such media devices include, but are not limited to, magnetic cassettes, flash memory cards, digital videodisks, Bernoulli cartridges, random access memories, nano-drives, memory sticks, other read/write and/or read-only memories and/or any other method or technology for storage of information such as computer readable instructions, data structures, program modules or other data. Any such computer storage media may be part of computing system environment 600.

A number of program modules may be stored in one or more of the memory/media devices. For example, a basic input/output system (BIOS) 624, containing the basic routines that help to transfer information between elements within the computing system environment 600, such as during start-up, may be stored in ROM 608. Similarly, RAM 610, hard drive 618, and/or peripheral memory devices may be used to store computer executable instructions comprising an operating system 626, one or more applications programs 628 (which may include the functionality of the digital image editing system 102 of FIG. 1 or one or more of its functional modules 108, 110, 112, for example), other program modules 630, and/or program data 622. Still further, computer-executable instructions may be downloaded to the computing environment 600 as needed, for example, via a network connection.

An end-user may enter commands and information into the computing system environment 600 through input devices such as a keyboard 634 and/or a pointing device 636. While not illustrated, other input devices may include a microphone, a joystick, a game pad, a scanner, etc. These and other input devices would typically be connected to the processing unit 602 by means of a peripheral interface 638 which, in turn, would be coupled to bus 606. Input devices may be directly or indirectly connected to processor 602 via interfaces such as, for example, a parallel port, game port, firewire, or a universal serial bus (USB). To view information from the computing system environment 600, a monitor 640 or other type of display device may also be connected to bus 606 via an interface, such as via video adapter 632. In addition to the monitor 640, the computing system environment 600 may also include other peripheral output devices, not shown, such as speakers and printers.

The computing system environment 600 may also utilize logical connections to one or more computing system environments. Communications between the computing system environment 600 and the remote computing system environment may be exchanged via a further processing device, such a network router 642, that is responsible for network routing. Communications with the network router 642 may be performed via a network interface component 644. Thus, within such a networked environment, e.g., the Internet, World Wide Web, LAN, or other like type of wired or wireless network, it will be appreciated that program modules depicted relative to the computing system environment 600, or portions thereof, may be stored in the memory storage device(s) of the computing system environment 600.

The computing system environment 600 may also include localization hardware 686 for determining a location of the computing system environment 600. In embodiments, the localization hardware 646 may include, for example only, a GPS antenna, an RFID chip or reader, a WiFi antenna, or other computing hardware that may be used to capture or transmit signals that may be used to determine the location of the computing system environment 600.

The computing environment 600, or portions thereof, may comprise one or more components of the system 100 of FIG. 1, in embodiments.

While this disclosure has described certain embodiments, it will be understood that the claims are not intended to be limited to these embodiments except as explicitly recited in the claims. On the contrary, the instant disclosure is intended to cover alternatives, modifications and equivalents, which may be included within the spirit and scope of the disclosure. Furthermore, in the detailed description of the present disclosure, numerous specific details are set forth in order to provide a thorough understanding of the disclosed embodiments. However, it will be obvious to one of ordinary skill in the art that systems and methods consistent with this disclosure may be practiced without these specific details. In other instances, well known methods, procedures, components, and circuits have not been described in detail as not to unnecessarily obscure various aspects of the present disclosure.

Some portions of the detailed descriptions of this disclosure have been presented in terms of procedures, logic blocks, processing, and other symbolic representations of operations on data bits within a computer or digital system memory. These descriptions and representations are the means used by those skilled in the data processing arts to most effectively convey the substance of their work to others skilled in the art. A procedure, logic block, process, etc., is herein, and generally, conceived to be a self-consistent sequence of steps or instructions leading to a desired result. The steps are those requiring physical manipulations of physical quantities. Usually, though not necessarily, these physical manipulations take the form of electrical or magnetic data capable of being stored, transferred, combined, compared, and otherwise manipulated in a computer system or similar electronic computing device. For reasons of convenience, and with reference to common usage, such data is referred to as bits, values, elements, symbols, characters, terms, numbers, or the like, with reference to various presently disclosed embodiments. It should be borne in mind, however, that these terms are to be interpreted as referencing physical manipulations and quantities and are merely convenient labels that should be interpreted further in view of terms commonly used in the art. Unless specifically stated otherwise, as apparent from the discussion herein, it is understood that throughout discussions of the present embodiment, discussions utilizing terms such as “determining” or “outputting” or “transmitting” or “recording” or “locating” or “storing” or “displaying” or “receiving” or “recognizing” or “utilizing” or “generating” or “providing” or “accessing” or “checking” or “notifying” or “delivering” or the like, refer to the action and processes of a computer system, or similar electronic computing device, that manipulates and transforms data. The data is represented as physical (electronic) quantities within the computer system’s registers and memories and is transformed into other data similarly represented as physical quantities within the computer system memories or registers, or other such information storage, transmission, or display devices as described herein or otherwise understood to one of ordinary skill in the art.

What is claimed is:

1. A method for editing a digital image, the method comprising:
receiving a user input indicative of a portion of an original digital image;
determining an area of a surface comprising the portion by applying a plurality of different masks to the original image and defining the surface as the area where at least two of the plurality of different masks agree;
receiving a user selection of a color to be applied to the original image to create a modified image;
determining a modified brightness value for each pixel of the surface in the modified image according to original brightness values of corresponding pixels in the original image; and
creating the modified image by applying the selected color to the surface according to the modified brightness values.

2. The method of claim 1, wherein the plurality of different masks comprises one or more of:
a segmentation mask;
a color mask; or
an edge mask.

3. (canceled)

4. The method of claim 1, wherein determining the area of the surface comprising the portion by applying the plurality of different masks to the image comprises defining the surface where all of the masks agree.

5. The method of claim 1, further comprising applying a morphological smoothing to boundaries of the area.

6. The method of claim 1, further comprising displaying the modified image to the user in response to one or more of the user input indicative of the portion of the original image or the user selection of the color.

7. The method of claim 1, further comprising receiving the original image from the user.

8. A non-transitory, computer readable medium storing instructions that, when executed by a processor, cause the processor to:
receive a user input indicative of a portion of an original digital image;
determine an area of a surface comprising the portion by applying a plurality of different masks to the original image and defining the surface as the area where at least two of the plurality of different masks agree;
receive a user selection of a color to be applied to the original image to create a modified image;
determine a modified brightness value for each pixel of the surface in the modified image according to original brightness values of corresponding pixels in the original image; and
create the modified image by applying the selected color to the surface according to the modified brightness values.

9. The computer readable medium of claim 8, wherein the plurality of different masks comprises one or more of:
a segmentation mask;
a color mask; or
an edge mask.

10. (canceled)

11. The computer readable medium of claim 8, wherein determining the area of the surface comprising the portion by applying the plurality of different masks to the image comprises defining the surface where all of the masks agree.

12. The computer readable medium of claim 8, storing further instructions that, when executed by the processor, cause the processor to apply a morphological smoothing to boundaries of the area.

13. The computer readable medium of claim 8, storing further instructions that, when executed by the processor, cause the processor to display the modified image to the user in response to one or more of the user input indicative of the portion of the original image or the user selection of the color.

14. The computer readable medium of claim 8, storing further instructions that, when executed by the processor, cause the processor to receive the original image from the user.

15. A system comprising:
a processor; and
a non-transitory computer-readable medium storing instructions that, when executed by the processor, cause the processor to:
receive a user input indicative of a portion of an original digital image;
determine an area of a surface comprising the portion by applying a plurality of different masks to the original image and defining the surface as the area where at least two of the plurality of different masks agree;
receive a user selection of a color to be applied to the original image to create a modified image;
determine a modified brightness value for each pixel of the surface in the modified image according to original brightness values of corresponding pixels in the original image; and
create the modified image by applying the selected color to the surface according to the modified brightness values.

16. The system of claim 15, wherein the plurality of different masks comprises one or more of:
a segmentation mask;
a color mask; or
an edge mask.

17. (canceled)

18. The system of claim 15, wherein determining the area of the surface comprising the portion by applying the plurality of different masks to the image comprises defining the surface where all of the masks agree.

19. The system of claim 15, wherein the computer-readable medium stores further instructions that, when executed by the processor, cause the processor to apply a morphological smoothing to boundaries of the area.

20. The system of claim 15, wherein the computer-readable medium stores further instructions that, when executed by the processor, cause the processor to display the modified image to the user in response to one or more of the user input indicative of the portion of the original image or the user selection of the color.
